(19) United States
(12) Patent Application Publication
(10) Pub. No.: US 2008/0295252 A1
(43) Pub. Date: Dec. 4, 2008

(54) Mattress Construction with Filamentary Fasteners

(75) Inventor: David Scott Cecil, Efland, NC (US)

Correspondence Address: SHOEMAKER AND MATTARE, LTD, 10 POST OFFICE ROAD - SUITE 110, SILVER SPRING, MD, 20910, US

(73) Assignee: KINGSDOWN, INCORPORATED, Mebane, NC (US)

(21) Appl. No.: 11/577,119

(22) PCT Filed: Oct. 11, 2005
(86) PCT No.: PCT/US05/36349

§ 371 Date: May 16, 2007

Related U.S. Application Data
(60) Provisional application No. 60/617,078, filed on Oct. 12, 2004.

(51) Int. Cl. A47C 23/04; B68G 7/05; B68G 7/12

(52) U.S. Cl. 5/721; 29/91.1; 29/91.7

(57) ABSTRACT

At least one major surface of the core is covered with an inner layer of insulation, and at least one outer layer of material. The outer layer is secured to the inner layer by inserting flexible filament type fasteners through the hollow needle of an installation tool. If the core is made of foam, filamentary fasteners may also be used to secure the inner layer. The insulation layers are ultimately covered and secured in place by a fabric panel which conceals and secures the other components. Filamentary fasteners may also be used to secure a pillow top edge or a top panel to the mattress.

### BACKGROUND OF THE INVENTION

This invention relates to a mattress and a method of making mattresses.

In conventional mattress construction, a metal innerspring unit—usually having an array of parallel coil springs surrounded top and bottom by respective border wires which define the edges of the mattress—is covered with layers of padding and fabric. Modern synthetic padding is commonly called “insulation”. Some of the insulation may be secured to the border wires, or to the coil springs, by metal connectors such as hog rings which are passed through the material and crimped around the underlying metal component. Other insulation layers may be attached at least temporarily by the use of adhesives or sewing. The insulation layers are ultimately covered and secured in place by a fabric panel which conceals the other components and presents a finished appearance.

Not all mattresses contain innersprings. Some, for example, have a high density foam core, or an air bladder. An innerspring is just one species of a mattress core. Whatever the construction, the purpose of the mattress core is to give the mattress shape, and to provide adequate support for a person lying on the mattress.

The fastening methods described above generally do not permit much free play between the joined layers, and have other drawbacks. For example, installing hog rings is labor-intensive, stitching is slow, and adhesive application can be messy and require cleanup.

We have found that filament-type plastic fasteners, of the type commonly used to secure sales tags to clothing, can be used to secure mattress components together, and that their use simplifies the manufacture of mattresses and results in a better product.

A typical tag fastener is a single piece of a strong plastic, having a slender, flexible strand connecting an enlarged head to an enlarge tail. The tail is too large to pass through clothing fabric, but the head—when turned sideways—can be passed between the fabric threads. A special tool is normally used to do this. Once the head is all the way through the fabric, on the opposite side from the tail, it is released and reassumes its natural position parallel to the fabric, so that it cannot be pulled back through. We refer below to fasteners of this type as “filamentary fasteners”, a phrase having some popular usage.

Plastic filament fasteners are manufactured joined in series as a strip or clip. An example of such a fastener clip is disclosed in U.S. Pat. No. 3,733,657, particularly FIG. 9. That clip includes a linear array of fasteners, each comprising a flexible filament having a transverse cross-bar forming a head at one end thereof and a paddle or a second transverse cross-bar forming a tail at the opposite end. In this construction, the transverse bar and the paddle (or second transverse bar) extend in planes parallel to one another. The respective transverse bars are spaced apart and oriented side-by-side and parallel to one another. A runner bar extending perpendicular to the respective transverse bars is connected to each of the transverse bars by a readily severable connector.

U.S. Pat. No. 4,039,078 discloses several different types of plastic fasteners, or attachments, which are fabricated as part of continuously connected ladder stock. In each instance, the ladder stock is formed from two elongated and continuous plastic side members coupled together by a plurality of plastic cross links, the cross links preferably being equidistantly spaced. The stock may be produced from flexible plastics material including nylon, polypropylene and other similar materials by molding or by stamping. The ladder stock, when cut, produces a plurality of individual fastener attachment devices. Each resulting fastener comprises a pair of end bars, preferably of the same length, which are coupled together by a thin filament. Each end bar of the fastener has an elongated cylindrical shape which is generally circular in lateral cross-section.

The dispensing of filamentary fasteners from a fastener stock strip is done with a hand-held trigger-operated device commonly referred to as a tagger gun. A tagger gun is constructed to accept a fastener strip. The gun body has a cylindrical opening into which a hollow needle having a longitudinal slot extending over its length is removably mounted. A strip of fastener stock is inserted into a slot in the housing which extends behind the needle. When the trigger is pulled, a plunger, aligned with the cross bar end of the first attachment in the fastener stock, is displaced forward such that the cross bar end of the first attachment in the stock is forced through the bore in the needle. Some tagger guns are manually operated while other tagger guns are powered by an electric motor or a pneumatic device.

The hollow needle of a tagger gun typically comprises a substantially cylindrical base portion having a front end, a rear end, a side surface, a central bore, a longitudinal slot and a recess on the side surface for accommodating a needle locking shaft. The hollow needle also comprises a stem portion which extends out from the front end of the base portion. The stem portion is a substantially cylindrically shaped needle which includes a sharpened tip, a longitudinal slot in alignment with the longitudinal slot in the base portion, and a central bore in alignment with the central bore in the base portion. A portion of the longitudinal slot near the tip of the stem portion is shaped to define an elongated opening (said portion being commonly referred to as the spoon of the needle) which is greater in size than the cross bar end of the fastener to be dispensed therethrough.

An example of such a needle which can be used as part of a filamentary fastener dispensing tool is disclosed in U.S. Pat. No. 5,715,984. That needle includes a knife portion on the rear end of the base portion. The knife portion includes a cutting edge, the entire length of the cutting edge being in the shape of a “V”-shaped notch.

Various types of tagger guns have been developed for use in dispensing individual filamentary fasteners from a supply of fastener stock. For example, U.S. Pat. No. 4,456,123 discloses an apparatus for dispensing fasteners. These and similar tools are sold by Avery Dennison Corporation of Pasadena, Calif., some under the registered trademark “Swiftach”. The tool can be used to store, feed and dispense fastener stock of the type described above.

U.S. Pat. Nos. 4,456,123, 5,715,984, 3,733,657 and 4,039,078 are incorporated herein by reference.

### SUMMARY OF THE INVENTION

An object of the invention is to simplify the construction of mattresses.

Another object is to provide a system of fasteners which, while securely retaining a material layer on a mattress, permit the layer or layers to move a limited amount relative to one another.

These and other objects are attained by constructing a mattress with injectable filamentary fasteners in lieu of conventional fasteners. We have found that flexible plastic fasteners of the type described above, properly installed, provide reliable and adequate retention of insulation and fabric layers during manufacture of a mattress. They have the advantages of being inexpensive, strong, and quick and easy to install. In addition, they may be used as “blind” fasteners when the underlying layer is thick, meaning they do not have to penetrate all the way through the underlying layer in order to work. When they are injected through a hollow needle into a thick foam layer, for example, the anchor structure at the leading end of the fastener pierces the foam and is securely retained in place. By using a sufficient number of such fasteners—the optimum number is a matter of routine experimentation—a secure union is achieved.

The optimum dimensions of the fasteners may also be determined experimentally. We currently expect that fasteners in lengths from one to three inches will be suitable for tacking pillow top insulation to a mattress, before the pillow top cover fabric is applied.

In another application, flexible plastic fasteners are used to join foam border pieces to a foam sheet to form a tray which covers an innerspring.

The fastening system of the present application can be used to secure a non-woven flange around the edge of a mattress. “Non-woven” is a term of art connoting fabrics which comprise polymeric fibers laid randomly upon one another, and surface bonded together. In this application, the fasteners are injected through the flange material, into the underlying insulation near the edge of the mattress.

Use of filamentary fasteners may make it possible to eliminate entirely the non-woven flange which is conventionally applied around the edge of the mattress. The flange is an intermediate item, sewn along the mattress edge, to which a mattress border strip is in turn attached, to keep it aligned with the edge of the mattress. We have found, however, that good alignment can be maintained simply by injecting flexible plastic fasteners directly through the doubled, sewn portion of a border strip and into the underlying insulation near the mattress edge in a pillow top construction.

The invention is also applicable to one-sided mattress construction, wherein the border material is mitered only at the bottom; a non-woven top flange, not mitered, may be connected by injecting plastic fasteners through it into the insulation.

### BRIEF DESCRIPTION OF THE DRAWINGS

In the accompanying drawings,

FIG. 1 is a perspective view of a mattress construction with injectable fasteners embodying the invention;

FIG. 2 is a perspective view of a strip of the fasteners used in this invention;

FIG. 3 shows a modified version of one such fastener,

FIG. 4 shows, in cross-section, an alternative construction in which the core of the mattress is a block of foam, rather than an innerspring;

FIG. 5 is a perspective view of an alternative method of construction;

FIG. 6 shows a panel being attached by a blind fastener to a mattress; and

FIG. 7 shows a pillow top corner secured by a filamentary fastener.

### DESCRIPTION OF THE PREFERRED EMBODIMENT

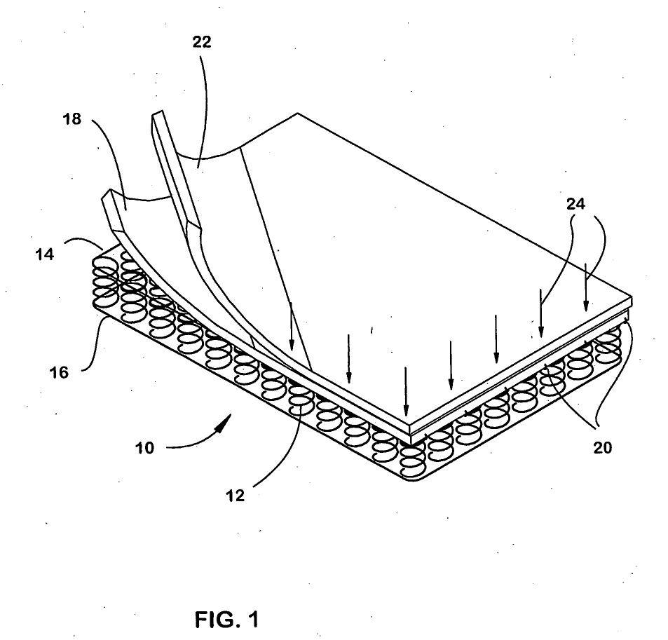

A mattress construction embodying the invention is shown in FIG. 1, which depicts a core element, in particular a metal innerspring unit 10, having an array of parallel coil springs 12 bounded top and bottom by respective border wires 14,16. It should be understood, however, that the invention is applicable to the manufacture of mattresses having other types of core elements. The core element may be, for example, a block of high density foam.

In the illustrated construction, at least one inner layer 18 of insulation is secured to the border wires, or to the coil springs, of the innerspring 10 by metal connectors such as hog rings 20 which are passed through the material and crimped around the underlying metal component, or by other means such as adhesives. The inner layer may be bonded fiber batting, or a non-fibrous material such as a polymeric foam.

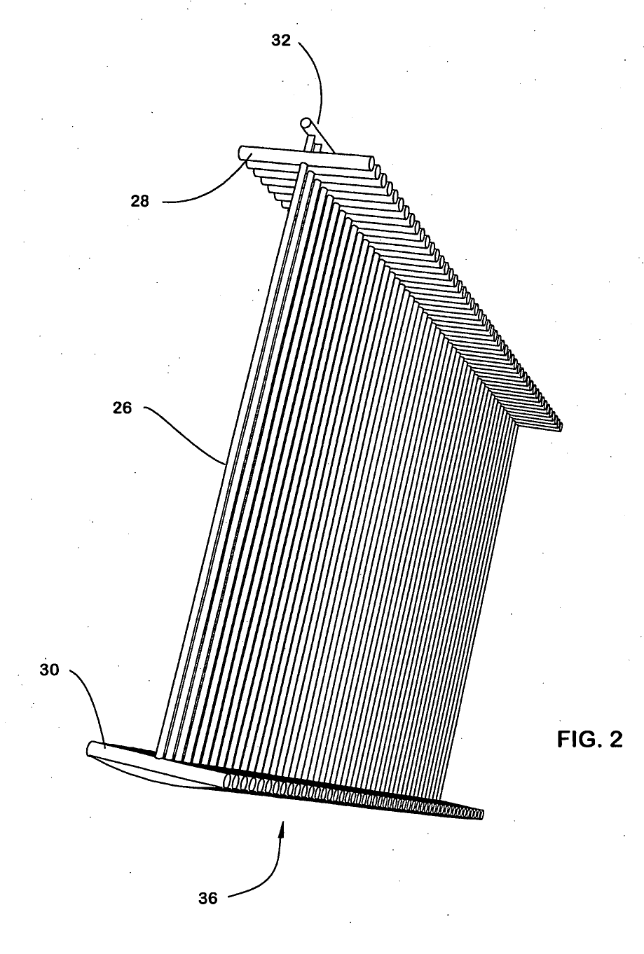

At least one outer layer 22 of insulation is then placed on top of the inner layer or layers, and is secured to the inner layer, according to this invention, by an array of filamentary fasteners 24 of the type described above and shown in FIG. 2. The outer layer may be, for example, a polymeric foam or other resilient material.

Each such fastener includes a substantially flexible polymeric filament 26 of from one to three inches (25 to 76 mm) in length, a substantially rigid head or anchor such as a cross-bar 28 at a forward end of the filament, and an enlargement or tail 30 (which may be a paddle or a second cross-bar) at the rear end of the filament. The individual fasteners are interconnected by a runner 32 near the heads 28, and the tails 30 may be connected to each other by readily breakable bonds (not shown) so as to form a clip or strip 36 of interconnected fasteners.

As shown in FIG. 1, the fasteners are inserted through the outer layer and into or through the inner layer by a gun (not shown) which holds a clip or strip 36 of interconnected fasteners (see FIG. 2), and injects them one at a time into the mattress through the gun's needle, which is inserted to the proper depth before the gun is actuated by pulling a trigger. This presumes the gun is being manipulated by a human. If, instead, the gun is made part of a machine which activates the gun automatically, it may have another type of actuating device, for example an electro-pneumatic actuator controlled by a computer or a microprocessor.

The insulation layers are ultimately covered and secured in place by fabric panels (not shown) which conceal the other components of the mattress and present a finished appearance. The fabric panels are interconnected by sewing machines, which may also automatically insert a reinforcing tape between the edges of the panels, at the edges of the mattress, to provide a good appearance.

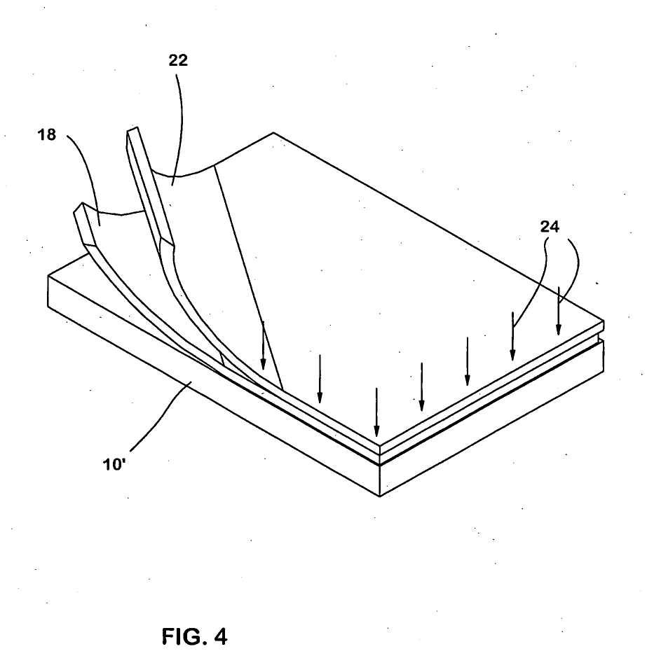

If, as shown in FIG. 4, the mattress core is a block of polymeric foam 10′, rather than an innerspring, filamentary fasteners 24 may be used as well to attach the first layer of insulation to the core. The fasteners are simply installed by injecting their heads through the insulation directly into the core.

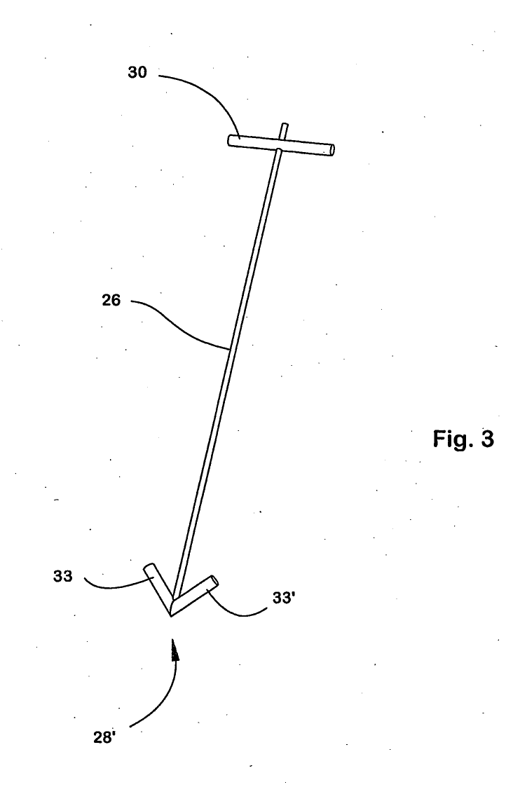

The filamentary fasteners illustrated in FIG. 2 were conventional, each having a head formed by a straight transverse bar. An alternative version of the filamentary fastener 24′ is shown in FIG. 3. It is characterized by the fact that its head or anchor 28′ is formed by two arms 33, 33′ which are not collinear, but rather meet at a vertex and subtend an angle of less that 180°, preferably an obtuse angle, thus forming an arrow head. We expect the arrow head anchor 28′ will provide improved retention strength, particularly in foam.

The enlarged tail 30 of the filamentary fastener, whether it be the type shown in FIG. 2, or in FIG. 3, may have various forms. Whatever its shape, it is too large to be pushed or pulled through fabric material of the type being used. It need not be a transverse bar, but could be a disc, paddle, prism, or any other structure that cannot be forced or pulled through the fabric.

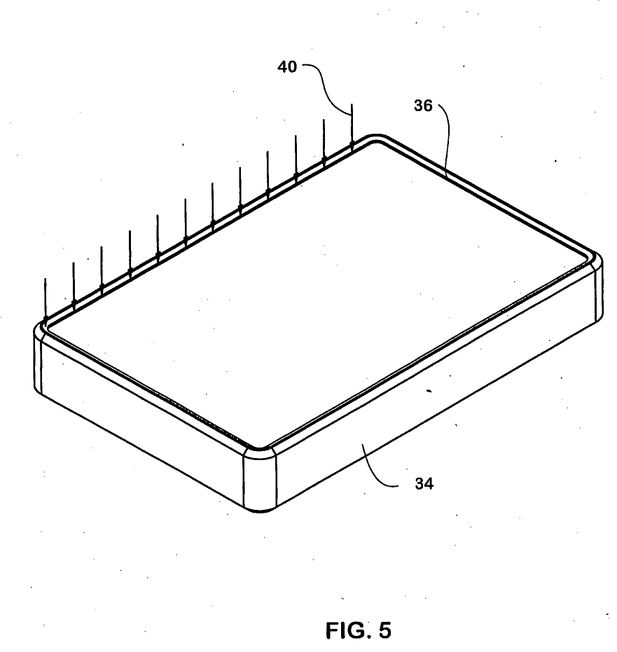

FIG. 5 shows an alternative method of construction, which is applicable to single-side mattresses. In this method, a mattress border band 34, which has a strong strip of material 36 called a “flange” attached to its upper edge, is pre-sewn along its bottom edge to the periphery of a bottom cover (not shown). The border is then pulled up around the mattress components from below, and the flange is pulled inward across the top of the mattress to tighten the border and the bottom cover. Filamentary fasteners 40 are then driven through the flange and into the mattress to secure the band in position. Following that step, a top cover panel 42 is sewn to the top edge of the border, preferably with a sewing machine (not shown) that adds a reinforcing tape which overlaps the seam. In a pillow top construction, the filamentary fasteners could be driven through the border material itself, rather than through the flange, to secure the border to the mattress.

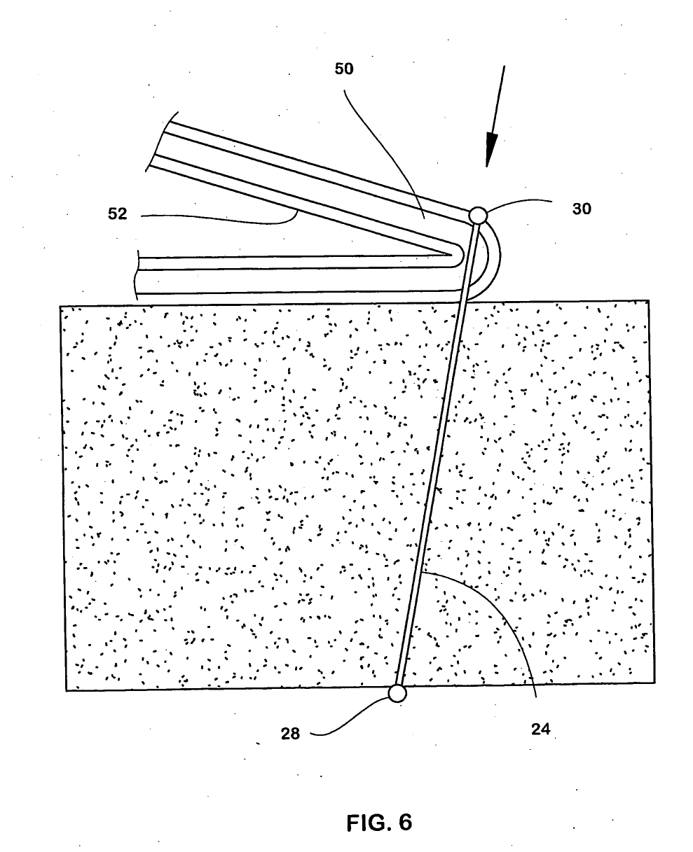

FIG. 6 illustrates a method of securing a multi-ply panel 50 to a mattress, using a filamentary fastener 24, in such a way that the tail of the fastener is invisible in the final product. The panel is folded along a fold line, and then the head 28 of the filamentary fastener is injected near the fold line through one or more, but not all, plies of the panel and into the underlying mattress to secure the panel to the mattress. The fastener does not penetrate what is ultimately the top layer 52 of the panel, so when the panel is unfolded and laid out flat on the mattress, no part of the filamentary fastener can be seen.

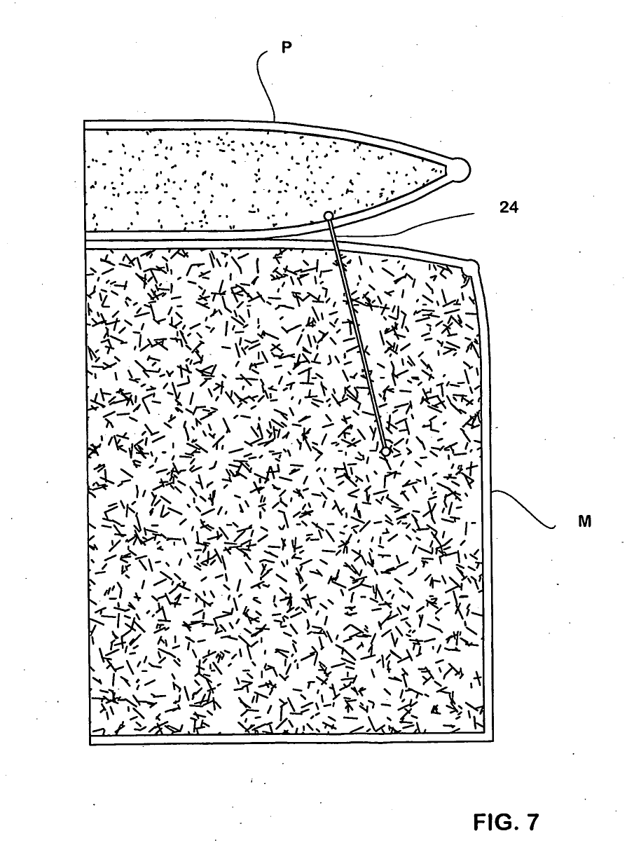

A pillow top mattress has an extra layer of insulation attached to the top of the mattress, enclosed by a pillow top edge which is permanently attached to the top of the underlying mattress along a line some distance inboard of the mattress edge. Thus the very edge of the pillow top is not secured to the mattress, and it may tend, particularly at the corners, to curl upward away from the mattress. We have found that this tendency can be countered by passing a filamentary fastener through the border of the pillow top “P”, and down into the underlying mattress material “M” at the corners or other suitable locations. The installation of one such fastener 24 is illustrated in FIG. 7.

Since the invention is subject to modifications and variations, it is intended that the foregoing description and the accompanying drawings shall be interpreted as only illustrative of the invention defined by the following claims.

I claim:

1. A mattress construction comprising
a mattress core,
at least one inner layer of insulation secured on at least one major surface of the core,
at least one outer layer of material disposed on said inner layer of insulation, and
an array of fasteners for securing said outer layer of material to said inner layer of insulation,
at least some of said fasteners comprising a flexible polymeric filament, a first enlargement at a forward end of the filament, and a second enlargement at a rear end of the filament,
at least said first enlargement being an anchor which can be passed through a hollow needle which has been pushed through the outer layer and into the inner layer so that when the needle is removed, the first enlargement deploys within or on a far side of the inner layer and the second enlargement deploys of the near side of the outer layer, thereby retaining the layers together while permitting limited movement between the layers.

2. A method of making a mattress, said method comprising steps of
covering at least one major surface of a mattress core with at least one inner layer of insulation,
placing at least one outer layer of material on the inner layer, and
securing said outer layer of material to said inner layer of insulation with an array of fasteners,
at least some of said fasteners comprising a flexible polymeric filament, a first enlargement at a forward end of the filament, and a second enlargement at a rear end of the filament,
wherein each said fastener is installed by pushing a hollow needle through the outer layer and into the inner layer, then passing the transverse bar through the needle so that when the needle is removed, the first enlargement deploys within or on a far side of the inner layer and the second enlargement remains on the near side of the outer layer, thereby retaining the layers together while permitting limited movement between the layers.

3. A method as recited in claim 1 or 2, wherein said first layer of material is a layer of insulation.

4. A method as recited in claim 1, 2 or 3, wherein said first layer of material is a fabric.

5. A method of making a mattress, said method comprising steps of
covering at least one major surface of a mattress core made of a polymeric foam with a layer of insulation, and
securing said layer of insulation to said core with an array of fasteners,
at least some of said fasteners comprising a flexible polymeric filament, a first enlargement at a forward end of the filament, and a second enlargement at a rear end of the filament,
wherein each said fastener is installed by pushing a hollow needle through the insulation and into the foam core, then passing the first enlargement through the needle so that when the needle is removed, the first enlargement deploys within the foam core and the second enlargement remains on the near side of the insulation, thereby retaining the insulation and the core together while permitting limited movement between the insulation and the core.

6. A method as recited in claim 1, 2, 3, or 4, wherein said insulation is a polymeric foam.

7. A filamentary fastener for mattress construction, said fastener comprising
a flexible strand of polymeric material,
an integral enlarged tail at one end of the strand, and
an integral enlarged head at the other end of the strand,
wherein the head comprises a pair of arms extending on opposite sides of the strand, the arms meeting at a vertex and subtending an angle of substantially less than 180°.

8. A method of securing a corner or edge of a pillow top to a mattress, said method comprising a step of injecting a filamentary fastener through at least the bottom layer of the pillow top into the mattress.

9. A method of securing a multi-ply fabric panel to a mattress, said method comprising a step of folding the fabric panel along a fold line, then
injecting a filamentary fastener through fewer than all plies of the fabric panel near the fold line, and into the mattress, and then
unfolding the fabric panel flat against the mattress so that the filamentary fastener is hidden by an outermost ply of the panel.

10. A method of securing a fabric top or bottom cover to a mattress core, said method comprising a step of sewing a flange strip of non-woven fabric to the periphery of the top or bottom cover, placing the top or bottom cover on the mattress core so that the flange strip extends over the edge of the mattress core, and then securing the flange strip to the mattress core by injecting filamentary fasteners through the flange strip and into the side of the mattress core.
